(19) United States
(12) Patent Application Publication
(10) Pub. No.: US 2002/0159803 A1
(43) Pub. Date: Oct. 31, 2002

(54) Device for engaging and disengaging a backup roller of a printing press

(75) Inventor: Lennardt Jader, Strande (DE)

Correspondence Address: Lawrence P. Kessler, NexPress Solutions LLC, Patent Department, 1447 St. Paul Street, Rochester, NY, 14653-7103, US

(73) Assignee: ZF Sachs AG

(21) Appl. No.: 09/850,047

(22) Filed: May 7, 2001

(30) Foreign Application Priority Data
May 18, 2000 (DE) 100 24 092.5

(51) Int. Cl. G03G 15/20

(52) U.S. Cl. 399/313

(57) ABSTRACT

A device for engaging and disengaging a backup roller of a printing press. The device includes two two-arm levers mounted on side parts, on which an arm is mounted capable of turning the backup roller. A guiding rod (26) is attached to the second arm, and has an adjusting cylinder. The backup roller is hinged with the guiding rod.

The invention concerns a device for engaging and disengaging a backup roller of a printing press, in particular in the case of an electrostatic printing press with a conveyor belt.

In the case of known printing presses the sheets to be printed are conveyed by means of a belt along printing modules. For transferring toner or printing ink from one cylinder of the printing module onto a sheet, which is conveyed to the belt, backup rollers are used which exert a force effect on the sheet against the cylinder from the underside of the belt. These backup rollers can be disengaged as needed. Springs are used to apply the required pressing forces.

A disadvantage of the known systems is that the engaging forces are not constant in the case of different adjusting paths. The spring hystereses exert an undesirable influence. Because no exact adjustment of the pressing force is possible in the case of the known systems, in the case of multiple color printing errors appear in the case or printing partial colors over one another.

Active systems with actors, which are a component of the control system, also can be used for creating constant pressing forces. Such systems are expensive with respect to materials and costs.

The object of the invention is to develop a device for engaging and disengaging a backup roller of a printing press, which ensures constant pressing forces reliably and at low cost.

The object is achieved with a device which has the features according to claim 1. Advantageous configurations follow from the sub-claims.

The force for generating the motion of engaging and disengaging backup rollers can be applied by the oppositely directed use of a mass body and a pneumatic cylinder, a bearing and guiding rod assuming the function of the mass body. The guide rod is hinged with the backup roller and is guided parallel to the printing roller via two guide levers. Shocks and vibrations can be absorbed by the pneumatic cylinder coupled with a damping system. The arrangement of the components makes a compensation of irregularities with respect to the position and dimensions of a backup roller and the associated cylinder possible.

This version of the invention has the advantages that the shock and vibration damping takes place through an integrated damping system, that a constant force guiding via a precisely definable mass body is possible, and the compensation of shape and position tolerances via a lever system is possible.

A further possibility consists in the fact that the motion of engaging and disengaging the backup rollers takes place by means of an adjusting cylinder mounted centrally, a bearing and guiding rod assuming the function of a compensating spring. The guiding rod is hinged with the backup roller and is guided parallel to the printing roller via two guide levers. The geometry and position of the guiding rod is chosen so that shocks and pressure fluctuations are largely absorbed or can be compensated. This arrangement of the components also makes it possible to compensate for the irregularities with respect to the position and dimensions of backup rollers and printing cylinder.

In the case of these versions there are the advantages that a force compensation takes place by mans of an elastic guiding rod, that a constant introduction of force via an adjusting cylinder, in particular a pneumatic cylinder, is possible, and that a compensation of shape and position tolerances is carried out via a lever system

The invention is to be explained in greater detail below by means of a specific embodiment, here:

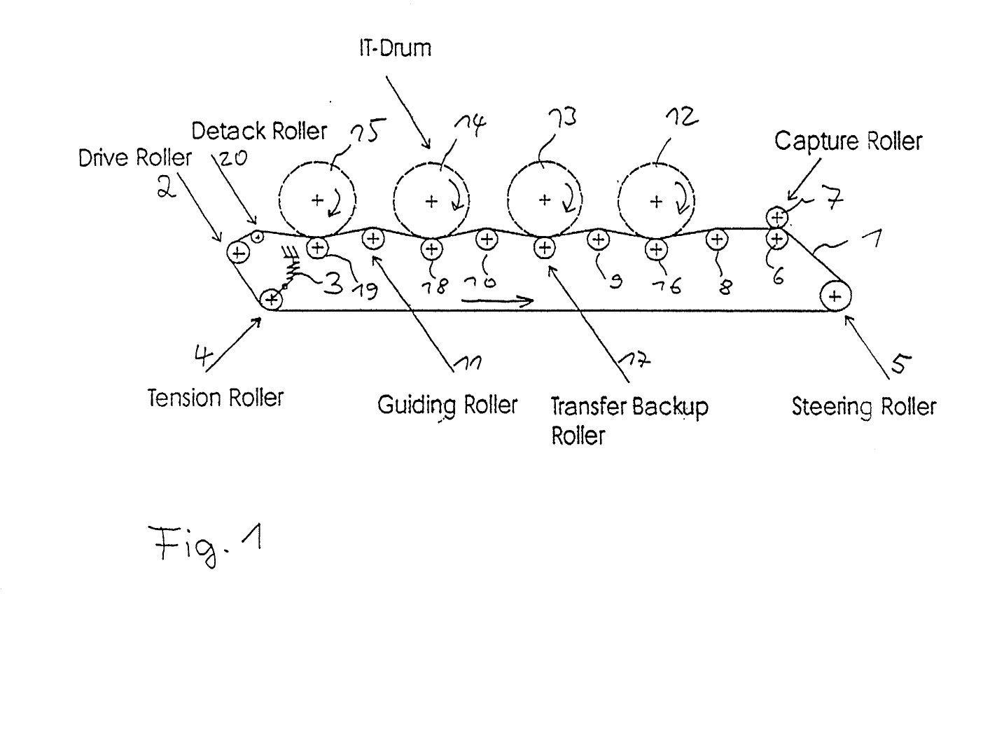

FIG. 1 shows a diagram of a printing machine with a conveyor belt,

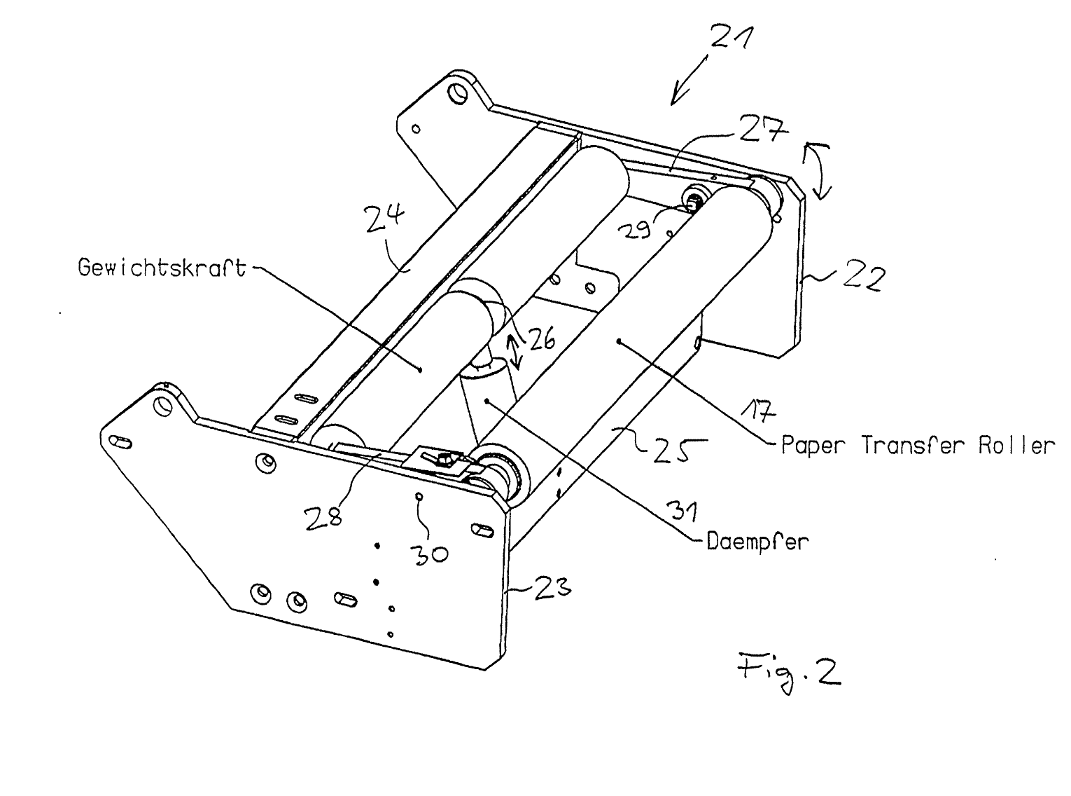

FIG. 2 shows a diagram of device for engaging and disengaging with a mass body, and

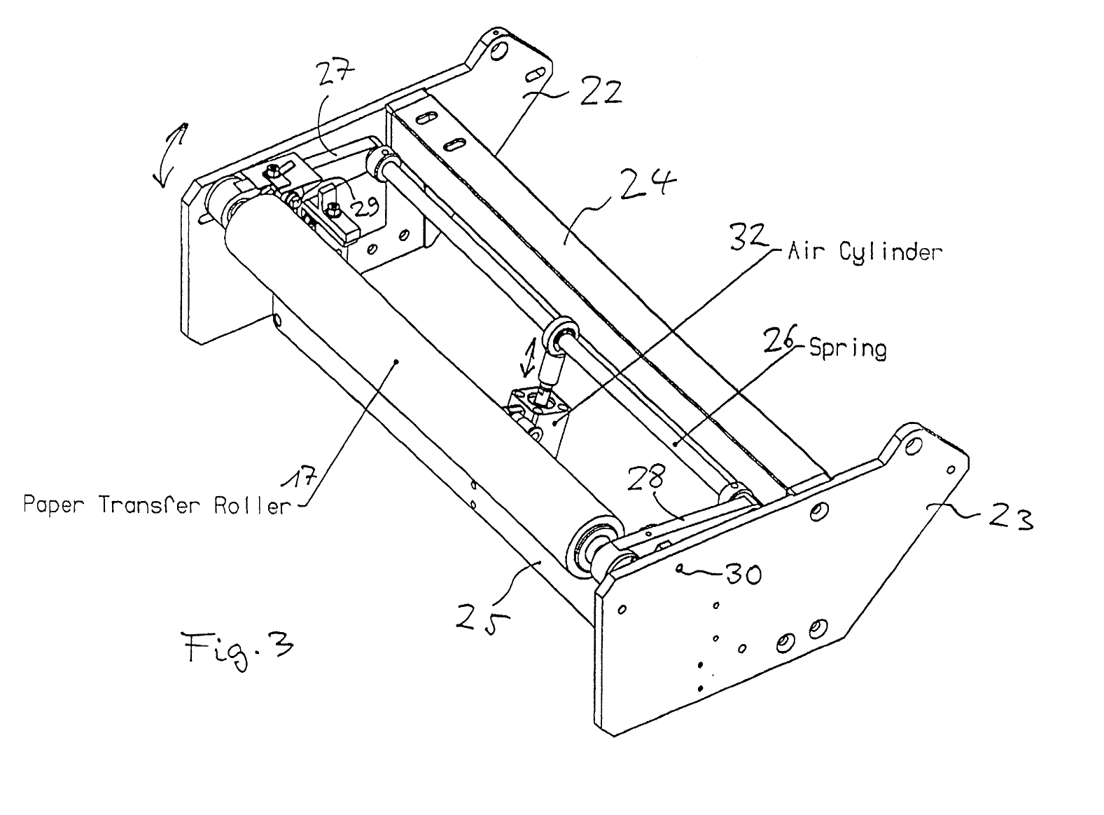

FIG. 3 shows a diagram of a device for engaging and disengaging with an elastic guiding rid.

The diagram in FIG. 1 shows a printing press with a conveyor belt system. A belt 1 is placed over a plurality of rollers. One roller 2 is used for driving the belt 1 in the direction of the arrow. A further roller serves as tightening roller by the action of a spring 3. A roller 5 capable of swiveling transverse to its turning axis is provided for lateral adjustment of the belt motion. A guide roller 6 acts together with a roller 7. Roller 7 is used for placing sheets, which are to be printed. Guide rollers 8, 9, 10, 11 cause a certain wrapping around cylinders 12, 13, 14, 15 which bear a printing image in the form of toner particles corresponding to the partial colors. Thus during the printing operation there is a definite pressing between the belt 1 with the sheet located on it and the cylinders 12, 13, 14, 15; backup rollers 16, 17, 18, 19 are provided which can be switched on and off from the underside of the belt 1. A further roller 20 is used for removing a sheet from belt 1.

How the backup rollers 16, 17, 18, 19 is to be performed by means of FIG. 2 is to be described below. Devices 21, which in each case have two side parts 22, 23 and crosspieces 24, 25, are mounted in the interior of the circular belt 1. A guiding rod 26 and a backup roller 16, 17, 18,19 are mounted capable of swiveling together on two two-arm guide levers 27, 28 between the side parts 22, 23. The bearings 29, 30 of the guide levers 27, 28 are found in the side parts 22, 23. The weight of the guiding rod 26 is greater than that of the backup rollers 16, 17, 18,19. A pneumatic cylinder 31, which is coupled with a damping system, is coupled in the middle on the guiding rod 26. In the case of the adjustment of the pneumatic cylinder 31 in the direction of the arrow the backup roller 16,17, 18, 19 is engaged and disengaged. Diameter fluctuations and eccentricities of the cylinders 12, 13, 14, 15 and the backup rollers 16, 17, 18, 19 also are compensated, as in the case of shocks appearing during transport and vibrations, by the weight force of the guiding rod 26 and the effect of the damping pneumatic cylinder 31.

FIG. 3 shows a further version of the invention. Components with the same function, as in FIG. 2, are provided with the same reference numbers. As opposed to FIG. 2, the guiding rod 26 is made as a spring rod, which acts compensating against shocks and vibrations of the backup force. The guiding rod 26 is coupled centrally with a pneumatic cylinder 32, which can perform a motion in the direction of the arrow, backup rollers 16, 17, 18, 19, in order to engage and disengage the backup rollers 16, 17, 18, 19.

What is claimed is:

1. A device for engaging and disengaging a backup roller of a printing press, consisting of two two-arm levers (27, 28) mounted on side parts (22, 23), on which an arm is mounted capable of turning the backup roller (16, 17, 18, 19) and a guiding rod (26) is attached to the second arm, and consisting of an adjusting cylinder (31) and the backup roller (16, 17, 18, 19) is hinged with the guiding rod (26).

2. The device according to claim 1, wherein the guiding rod (26) is made as a mass body.

3. The device according to claim 2, wherein the weight of the guiding rod (26) is greater that that of the backup roller (16, 17, 18, 19).

4. The device according to claims 1 and 2, wherein the adjusting cylinder (31) is a pneumatic cylinder, which is combined with a damping cylinder.

5. The device according to claim 1, wherein the guiding rod (26) is made spring-mounted.

6. The device according to claim 5, wherein the adjusting cylinder (31) is a pneumatic cylinder.
